(19) United States
(12) Patent Application Publication
(10) Pub. No.: US 2008/0178122 A1
(43) Pub. Date: Jul. 24, 2008

(54) SYSTEM AND METHOD FOR WEBSITE CONFIGURATION AND MANAGEMENT

(75) Inventor: Barry Jay Besecker, Xenia, OH (US)

Correspondence Address: LAHIVE & COCKFIELD, LLP, ONE POST OFFICE SQUARE, BOSTON, MA, 02109-2127, US

(73) Assignee: CROWN PARTNERS,LLC, Dayton, OH (US)

(21) Appl. No.: 11/618,394

(22) Filed: Dec. 29, 2006

Related U.S. Application Data
(60) Provisional application No. 60/764,934, filed on Feb. 3, 2006.

(51) Int. Cl. G06F 3/048

(52) U.S. Cl. 715/854

(57) ABSTRACT

A web publishing enhancement application is discussed that provides a tool for visually creating an enhanced site map for a web site. The site map provides a location for creating web site content and site navigation. A user is also able to edit pages directly from the site map. The present invention also integrates CSS style classes within HTML content. The CSS style classes may be edited simultaneously by multiple users thus allowing the users to work concurrently. Additionally, a user is able to modify HTML code embedded in an XSL template from the site map and have the changes reflected in all of the pages created from the XSL template without knowledge of XSL or the rights of a developer. A page creation tool to create pages for websites using XML schemas, rule sets and XSL to create and edit XML files is also discussed.

### FIELD OF THE INVENTION

The illustrative embodiment of the present invention relates generally to web publishing and more particularly to a flexible and scalable automated system for the creation and management of websites.

### BACKGROUND

Web publishing applications publish graphics, text, sound, video or other content to an internet or intranet site. Web publishing applications (the term as used herein includes web content management (WCM) applications) may also schedule content for publishing onto the web, provide a lifecycle controlling the development process for content including the amount of time the content stays on the web, provide tools for searching and editing page files, provide for backups and provide archiving of pages to preserve institutional memory among other features. In recent years, an increasing number of web publishing applications have been developed which attempt to simplify the web publishing process. For example, Web Publisher from EMC Corporation of Hopkinton, Mass. provides a browser-based interface that enables users to create, manage and publish content for multiple, multilingual Web sites (Web Publisher is part of EMC's Documentum® family of enterprise content management (ECM) products).

Unfortunately, conventional web publishing and web content management applications suffer from a number of drawbacks. Conventional mechanisms in web publishing applications do not provide a site map from which a user can generate navigation files, display the site structure to the user and edit files directly. Additionally, conventional mechanisms of web publishing fail to provide cascading style sheet (CSS) style classes that may be edited simultaneously by multiple users from a content authoring view. Another drawback for conventional approaches to web publishing is that in approaches where content and presentation are separated using Extensible Markup Language (XML) and Extensible Stylesheet Language (XSL), the ability to modify XSL is restricted to developers and administrators. In addition, XSL frequently contains embedded Hypertext Markup Language (HTML) which users must provide to the developers for insertion into XSL stylesheets.

### BRIEF SUMMARY

The illustrative embodiment of the present invention is a web publishing enhancement application that provides a tool for visually creating an enhanced site map for a web site using a graphical user interface. The site map provides a view of web site structure and a location for creating web site content and site navigation. A user is also able to edit pages directly from the site map. The present invention also integrates CSS style classes within HTML content. The CSS style classes are separated into objects and may be edited simultaneously by multiple users in a design view thus allowing the users to work concurrently. Additionally, the present invention enables a user to modify HTML code embedded in an XSL template and have the changes reflected in all of the pages created from the XSL template without knowledge of XSL or the rights of a developer. The present invention also provides a page creation tool to create pages for websites using XML schemas, rule sets and XSL to create and edit XML files.

In one aspect of the present invention a method for creating an enhanced site map for a web site includes the step of providing a user interface to a web publishing application. The user interface enables the creation of a site map for a web site with multiple pages. The site map provides a view of a web site structure and a location from which to create site content and site navigation. The method also creates the site map with the user interface.

In another aspect of the present invention a method for utilizing CSS (Cascading Style Sheet) style classes with a web publishing application includes the step of importing a CSS file to a web publishing application. The method also parses each of multiple CSS classes within the CSS file into separate objects. Each separate object corresponds to a CSS class. Additionally, the method edits one of the separate objects and then remerges the multiple objects, including the edited object, into a merged CSS file.

In an additional aspect of the present invention, a system for creating pages for web sites includes multiple XML templates. The system also includes a universal XML schema that defines multiple XML schemas that are included in the XML templates. Each of the XML schemas defines structure for at least a portion of a page being generated using at least one of the XML templates. The system also includes at least one rule set. The rule sets are associated with at least one of the XML schemas and direct the drawing of a dialog box through which a user may specify a control to be included on the page being generated using the XML template. The system additionally includes a user interface that enables the selection of at least one of the XML templates by a user.

### BRIEF DESCRIPTION OF THE DRAWINGS

The invention is pointed out with particularity in the appended claims. The advantages of the invention described above, as well as further advantages of the invention, may be better understood by reference to the following description taken in conjunction with the accompanying drawings, in which:

FIG. 1 depicts an environment suitable for practicing an embodiment of the present invention;

FIG. 2 depicts an alternate environment suitable for practicing an embodiment of the present invention;

FIG. 3 is a flowchart of a sequence of steps followed by an illustrative embodiment of the present invention to create a site map;

FIGS. 4A-4L are a series of screenshots depicting the user creation of a site map of the present invention;

FIG. 5 is a flowchart of a sequence of steps by which a user may utilize an embodiment of the present invention to modify embedded HTML in a template;

FIGS. 6A-6I are a series of screenshots depicting the user modification of embedded HTML in a template in an illustrative embodiment of the present invention;

FIG. 7 is a flowchart of a sequence of steps followed by an illustrative embodiment of the present invention to import CSS files; and

FIGS. 8A-8B depict the user importing CSS files in the present invention.

### DETAILED DESCRIPTION

The illustrative embodiment of the present invention provides an application layer that interacts with a web publishing application to provide automation of the website authoring, configuration and management process. The web publishing enhancement application of the present invention provides a series of wizard interfaces that allows business users to generate the components necessary to author content. The wizard interfaces may be utilized by a user to manage the text, layout and style that make up the content of a web site. The web publishing enhancement application also automates the construction and configuration of websites while hiding implementation details from non-technical users. The illustrative embodiment of the present invention includes an enhanced site map available during site configuration, integrated CSS classes that may be edited simultaneously by multiple users, editable XML templates which users can edit by editing embedded HTML and the use of XML schemas, rule sets and XSL to generate web pages.

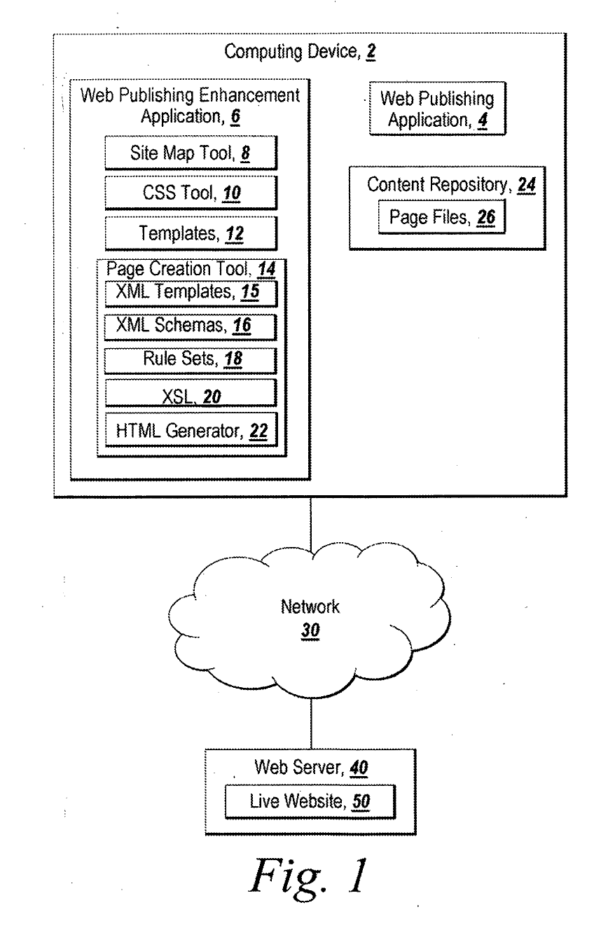

FIG. 1 depicts an environment suitable for practicing an embodiment of the present invention. A computing device 2 hosts a web publishing application 4 and the web publishing enhancement application 6 of the present invention. The computing device 2 may be a PC, workstation, server, laptop, mainframe, PDA or other computing device equipped with a processor and capable of hosting the web publishing application 4 and web publishing enhancement application 6. The computing device 2 may be equipped with a single processor, a multi-core processor, or multiple processors. The processor may be a 32 bit processor, 64 bit processor or some other type of processor capable of executing the instructions required for the present invention. The web publishing application 4 may be at application directed solely to the publishing of content to a web site or may also include web content management (WCM) functionality directed to management of the content. The term “web publishing application” as used herein should be understood to also include “web content management” applications. An exemplary web publishing application 4 is Web Publisher from EMC Corporation. The web publishing enhancement application 6 of the present invention may be implemented as a plug-in application for the web publishing application 4, as a separate application communicating with the web publishing application, or as another type of executable process capable of the functionality described herein. Alternatively, the functionality possessed by the web publishing enhancement application 6 may be integrated into a web publishing application. An exemplary web publishing enhancement application 6 is Site Builder™ from Crown Partners of Dayton, Ohio.

The web publishing enhancement application 6 includes a site map tool 8, a CSS tool 10, templates 12 and a page creation tool 14. The site map tool 8 is used to create an enhanced site map for a website. The site map tool 8 and the site maps created using the tool are discussed further below. The CSS tool 10 is used to import CSS files into a web site and is also discussed further below. The templates 12 are the forms and the related layout with embedded HTML that are used by contributors to create Web pages that are then automatically rendered into HTML after the user has finished editing. The page creation tool 14 includes XML templates 15 and pre-configured XML schemas 16 for the title, body and description of pieces of web pages being constructed. The page creation tool 14 also includes at least one rule set 18 that provides a dialog box into which a user may enter information to specify controls for a web page being constructed, and an XSL style sheet 20 that is applied to the XML file and controls the display of the web page.

The computing device 2 also includes a content repository 24 that holds a collection of page files 26 for a web site that is under construction. The page files 26 created by a user may be stored in the content repository 24 until they are ready to be posted to a live website 50. The computing device 2 communicates over a network 30 with a web server 40 hosting the live website 50. The publishing of content to the live website 50 is controlled by the respective lifecycles for the page files 26. The network 30 may be an internet, the Internet, a local area network (LAN), a wide area network (WAN), a wireless network, an intranet, an extranet or some other type of network. It should be recognized that the arrangement of system components depicted in FIG. 1 is meant as a singular example of one of many possible environments suitable for practicing the present invention.

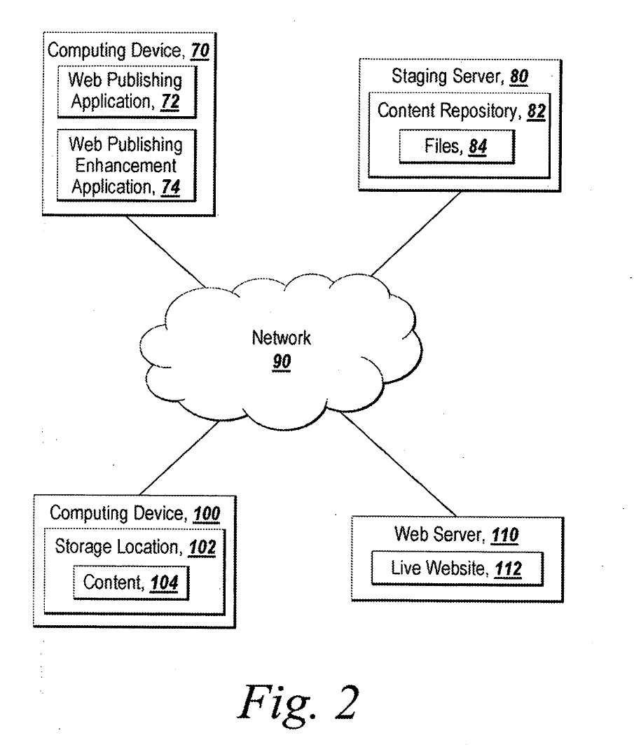

FIG. 2 depicts an alternative distributed environment. A computing device 70 hosts a web publishing application 72 and the web publishing enhancement application 74 of the present invention. The computing device 70 communicates over a network with remotely located computing device 100, staging server 80 and web server 110. The web publishing enhancement application 74 allows a user to add content 104 from storage location 102 to websites created or edited with the web publishing enhancement application. The page files 84 created may be saved in a content repository 82 on the staging server 80 while the user tests the page files. After activation, page files 84 may be transferred to the web server 110 for publication on the live website 112. Those skilled in the art will recognize that other architectures are also possible within the scope of the present invention.

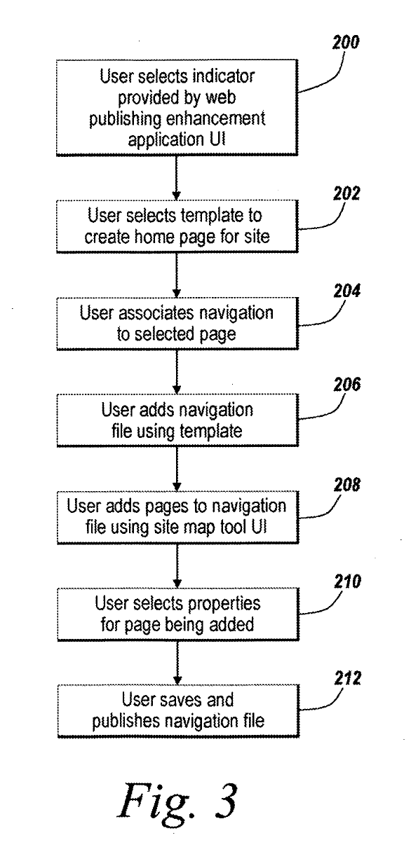

The process by which the web publishing enhancement application 74 creates an enhanced site map for a website is illustrated in the flowchart of FIG. 3. The site map provides a location for creating site navigation, a mechanism for creating “stub pages” for the site structure, and also provides documentation of the site structure. The “stub” pages function as empty placeholders initially providing structure for the site architecture that will later receive content. The sequence of creating the site map begins when the user selects an indicator provided by the web publisher enhancement application (step 200). The user then selects a template to create a home page (step 202). After creation of the home page, the user associates navigation with the home page (step 204). The navigation provides a set of links, usually on the left side or top of a page, that give the user the capability to navigate through a website. The user adds a navigation file using a template (step 206). The user then adds pages to the navigation file via the site map tool UI (step 208). For each page added, the user selects the properties for the page being added. The user may select the label displayed on the navigation as well as normal and highlight style classes. After selecting the properties for the navigation file, the user saves and publishes the navigation file (step 212).

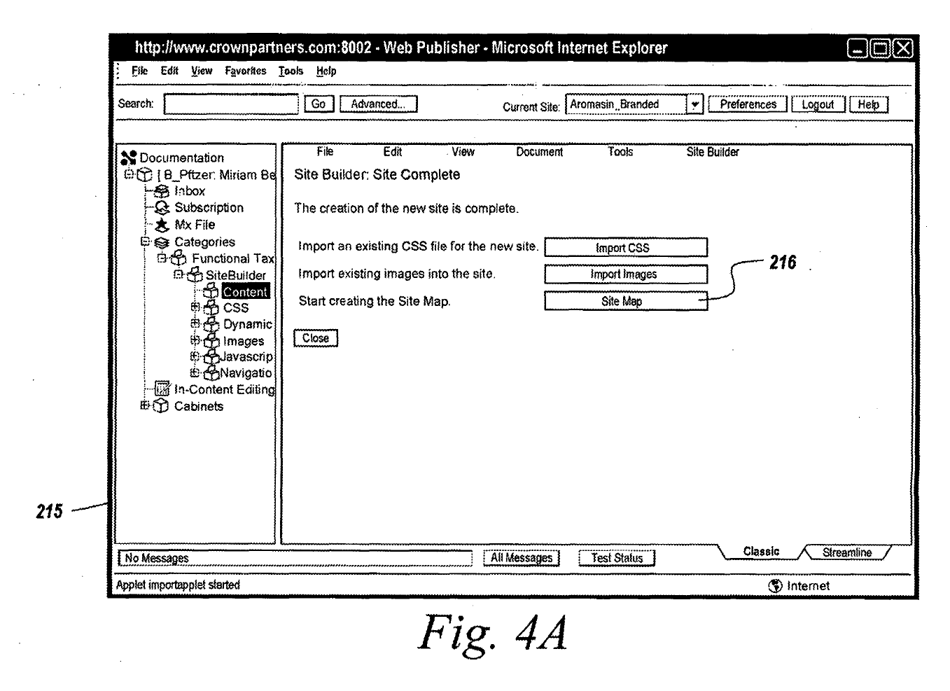

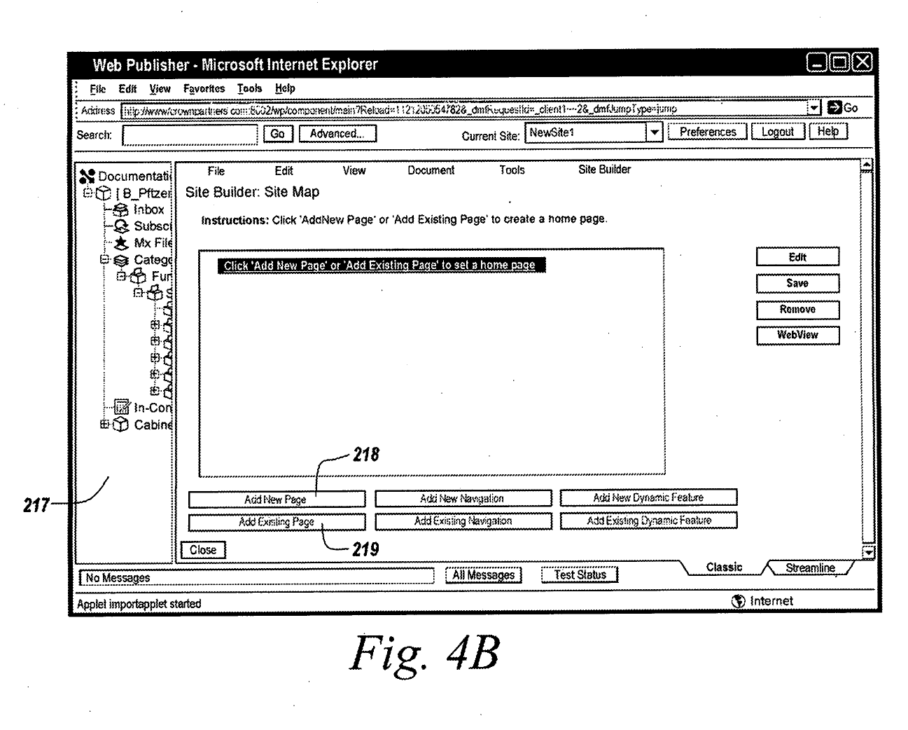

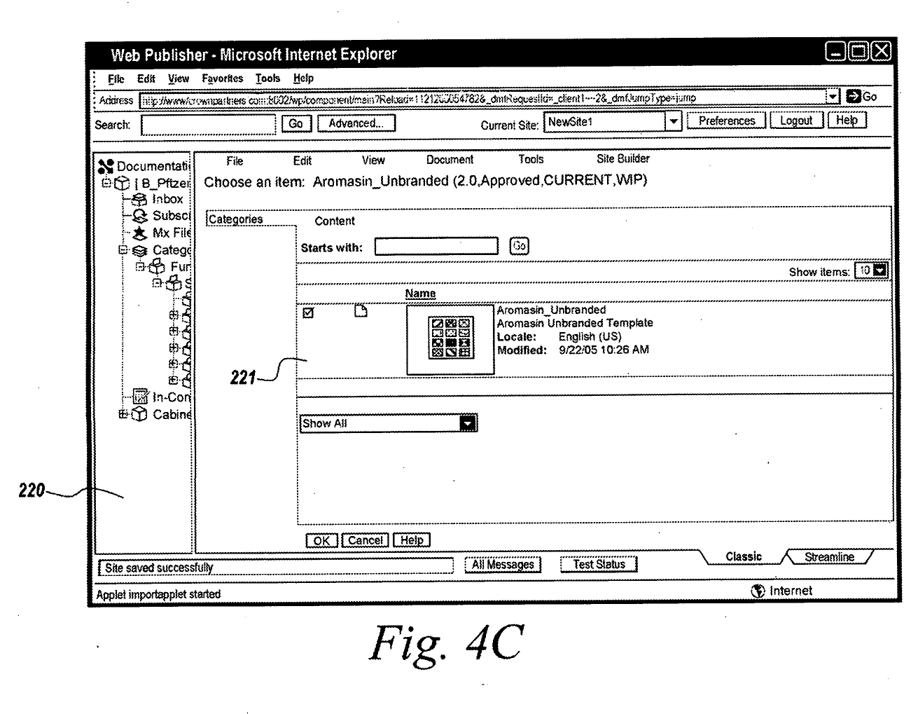

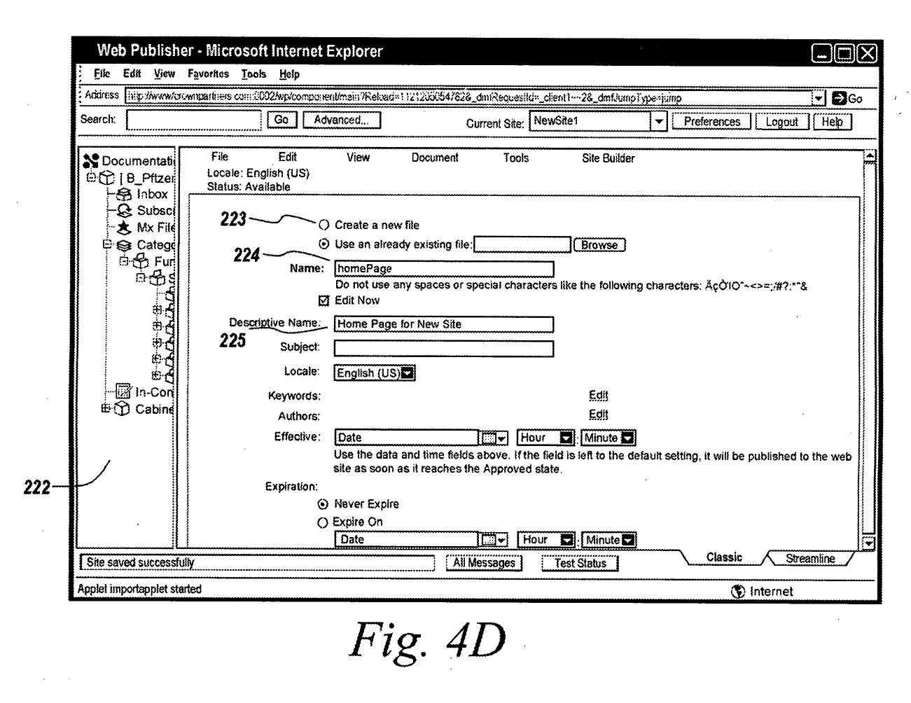

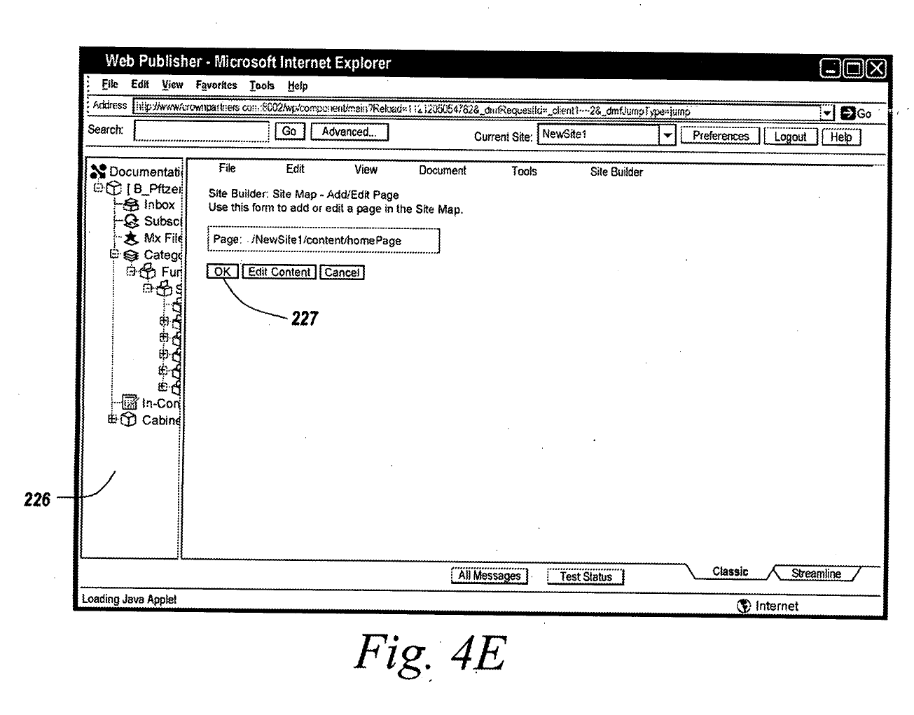

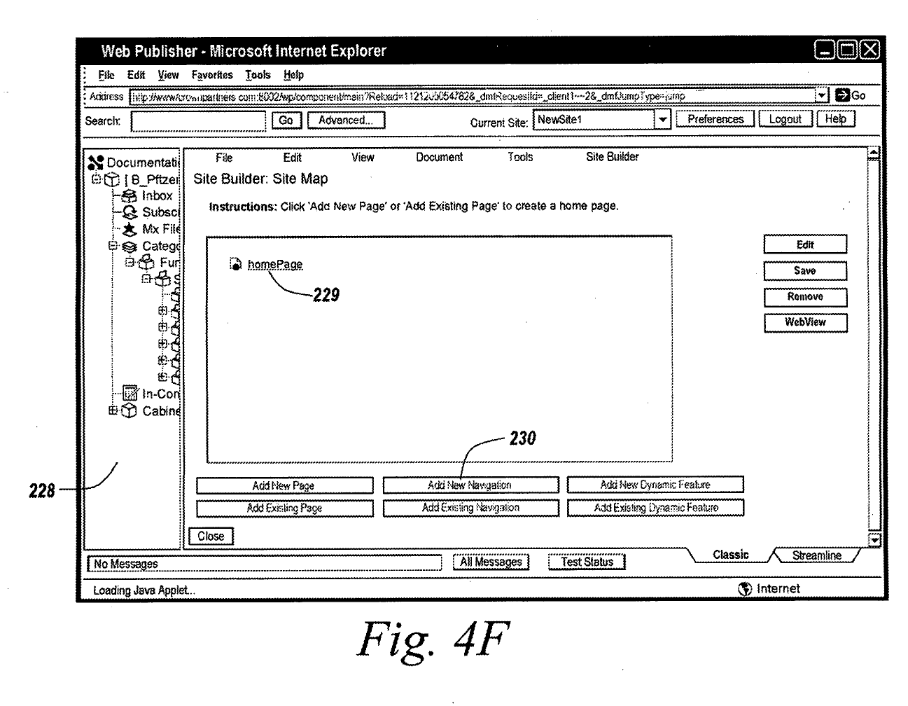

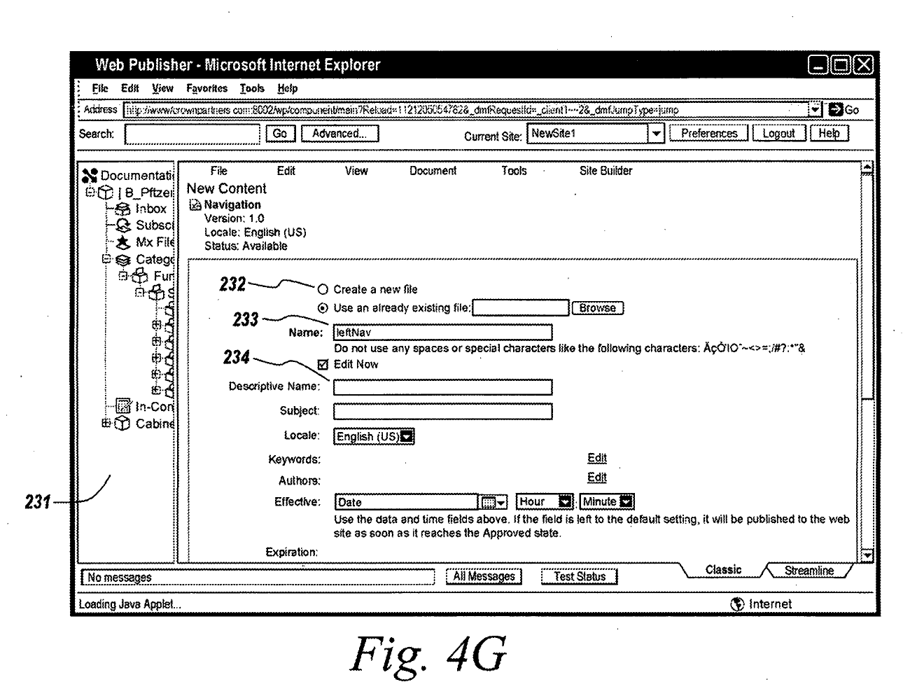

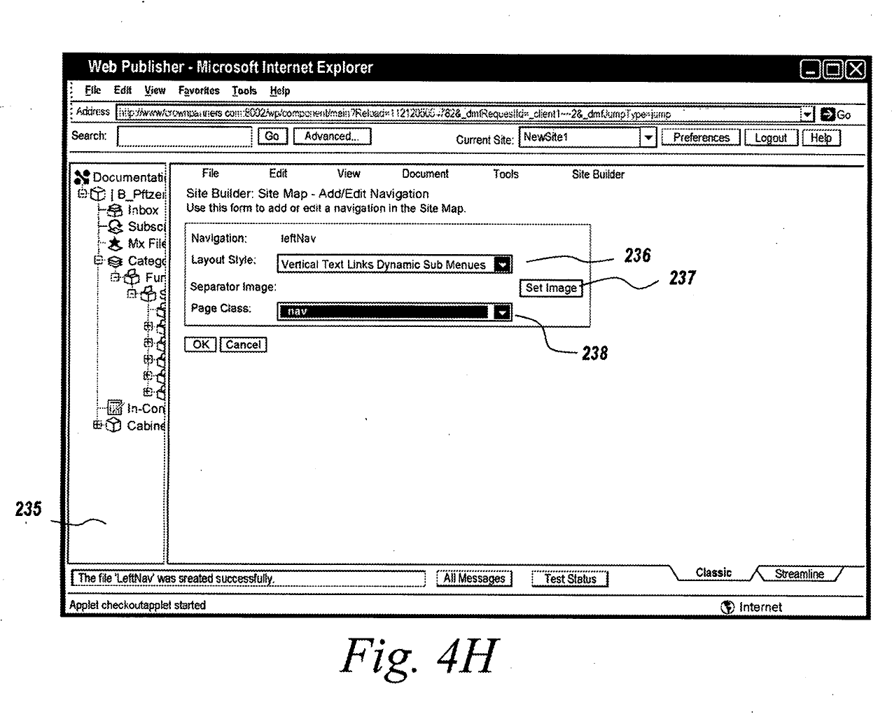

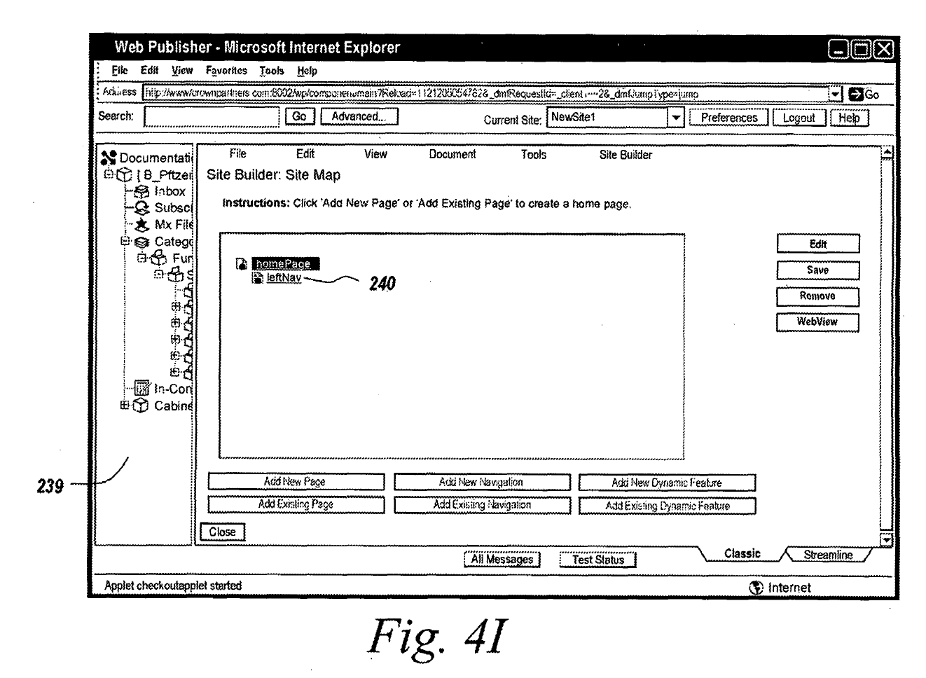

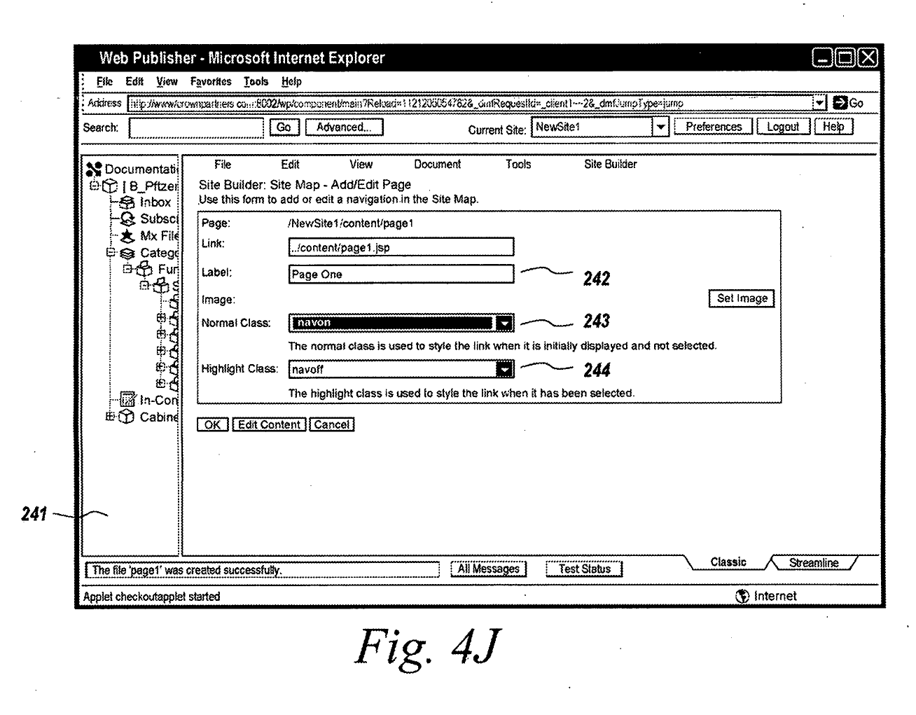

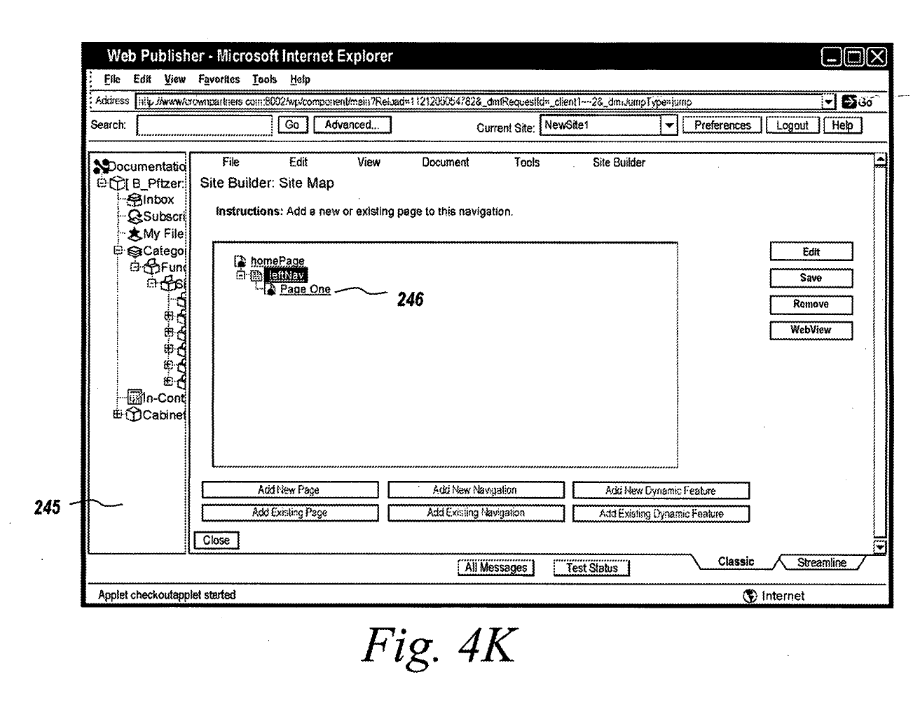

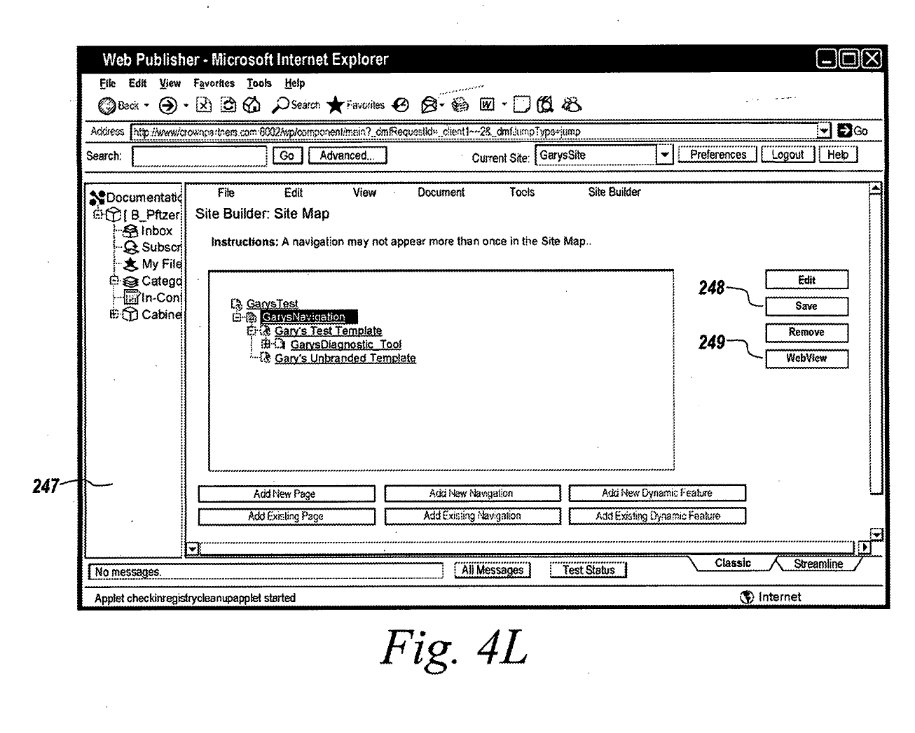

Examples of the user interface that may be used by the web publishing enhancement application to create the enhanced site map of the present invention are illustrated in the screenshots of FIG. 4A-4L. FIG. 4A is a screenshot 215 of the initial graphical user interface from which the user begins the process of creating the enhanced site map by selecting an indicator 216. FIG. 4B shows the subsequent screenshot 217 displayed as a result of the selection of the indicator 216 which includes indicators for either adding a new page 218 or designating an existing page 219 as a home page. FIG. 4C is a screenshot 220 of a graphical user interface from which the user can select a site template 221 that is to be used in creating the home page. FIG. 4D is a screenshot 222 of a graphical user interface from which the user creates the new home page and enters information. The graphical user interface includes a radio button 223 for creating a new file, a name textbox 224 for entering the name of the home page and a descriptive name textbox 225 for entering a name that will be the default label for the home page if it is added to navigation at a later time. FIG. 4E is a screenshot 226 of the graphical user interface which includes an indicator 227 which may be selected to add the home page for which the user entered information to the site map.

FIG. 4F is a screenshot 228 of the graphical user interface of the site map of the present invention from which a user may select a page 229 in order to associate a navigation file with the page through the selection of an indicator 230. FIG. 4G displays the resulting screenshot 231 that is displayed following the user's indication of a desire to add a navigation file to associate with a selected page from the site map. The adding new navigation interface includes a radio button 232 to create a new file, and text boxes 233 and 234 for entering a name and descriptive name for the navigation file. FIG. 4H displays a screenshot 235 of a layout selection page for the navigation page which allows the user to select a layout style 236, a separator image 237 and a page class 238. The site map allows the user to add additional pages to the navigation file. FIG. 4I is a screenshot 239 showing the association of the navigation file leftNav 240 with the selected page. The graphical user interface includes controls which may be selected to add additional new or existing pages to the navigation. FIG. 4J is the screenshot 241 of a resulting navigation properties page winch allows a user to specify a label 242, normal style class 243 and highlight style class 244 for the page being added to the navigation. FIG. 4K is a screenshot 245 of the site map showing the hierarchical representation of the newly added Page One 246 being added to the navigation file. After adding pages to the navigation and creating features the user may save and publish by selecting a save button 248 and webview button 249 as shown in the screenshot 247 of the site map in FIG. 4L.

In one embodiment, for large sites where the entire site map cannot be viewed within one screen without scrolling, for example sites with 200 or more pages, the Site Map provides a grouping mechanism. Groups of pages (such as groups of 50 pages) are named so that they are analogous to a “geography” of the site. Groups of pages at the lowest level can be considered “villages” if one were to compare this grouping mechanism to a physical geography. Similar to the manner in which villages can be grouped into counties, counties into states, states into countries, countries into nations, and nations into hemispheres, etc., the “village” groupings of pages at the lowest level of a site may be displayed as part of a broader group of pages. Those skilled in the art will recognize that the number of pages in the grouping may be configurable and vary with the particular implementation.

The grouping mechanism for site maps with large numbers of pages provides a level of “resolution” at which a user can view the site or multiple sites. Users may start at the top level and pan from a broad grouping of pages to another broad grouping of pages, zoom in within a broad grouping, pan and zoom further all the way down to a grouping of pages at the lowest level. At the lowest level the user can pan to other low level groupings of pages or directly edit/create/delete/expire pages and navigations. Networks of pages within the site map can be selectively expanded and collapsed to provide an additional layer of resolution. This capability will simplify the use of page networks by hiding layers of complexity. A thumbnail of the user's current location on the site map at the highest level of aggregation may also be provided. Color coding of the site map may be added. The fading of other areas of the map may be used to give context. A compass rose may provide navigation means. A “road sign” or other indicator that indicates the number of other users in that area, traffic, site use statistics, construction, or other analogous metrics may also be provided.

Once the site map has been created and pages developed, the site map allows a user to navigate a site as they would using a browser but with the ability to edit the page layout, template and content. The user is able to select a template for editing and is then allowed the opportunity to edit the embedded HTML in the template. As a result, the user is able to edit HTML, rather than another less familiar markup language. The site map also enables the user to edit the layout for the site.

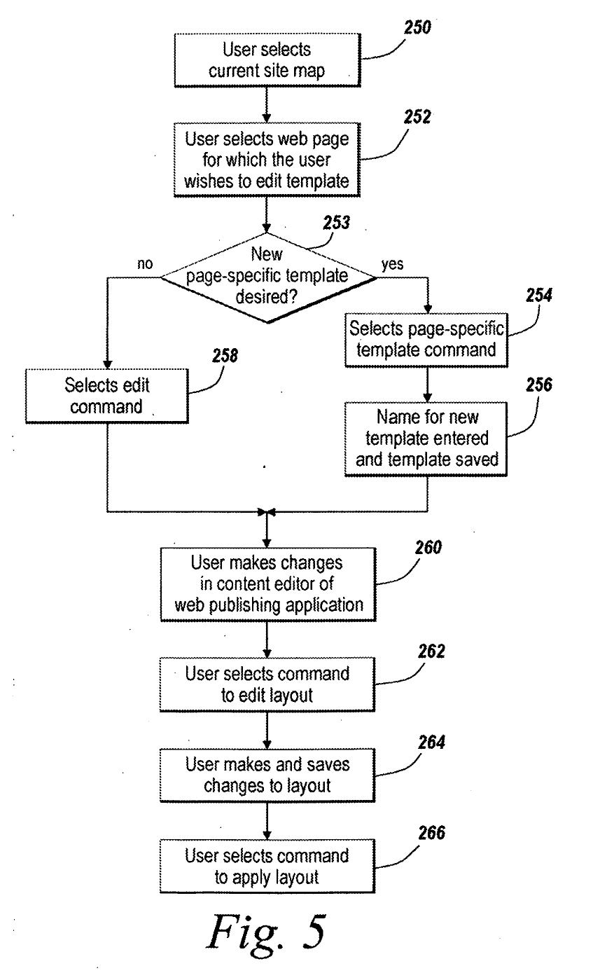

The process by which the user may edit template embedded HTML code in a web page using a site map is illustrated in the flowchart of FIG. 5. The sequence begins with the user selecting the current site map (step 250). The user then selects the web page for which the user wishes to edit the template (step 252). The user decides (step 253) whether to edit an existing template or create a page-specific template. In the event the user wishes to edit the existing template, the user selects an edit command to edit the template-embedded HTML code associated with the selected page (step 258). In the event the user wishes to create a page-specific template, the user selects a command to create anew page-specific template from the site map tool (step 254). The user names and saves the new template (step 256). For both the old template being edited and the newly created page-specific template the user may make changes to the HTML code using the content editor of choice (step 260). Notepad™ is an example of a commonly used HTML editor. For the existing template being edited, the changes made affect all of the new pages constructed using the template. Users may also apply the changes to existing pages.

The site map of the present invention allows the user to go directly from editing the content of the template to editing the layout by selecting a provided command (step 262). The ability of the user to edit the layout of the template allows the user to add content that is common across all pages such as navigation header images and layout code into the layout. The user makes and saves the changes (step 264) and then selects a command to apply the new layout to the current content file (step 266). Once the layout has been saved, the user may also make a copy of the layout that may be displayed in the in-context editor of the underlying web publishing application using the existing content but without applying it to the content file.

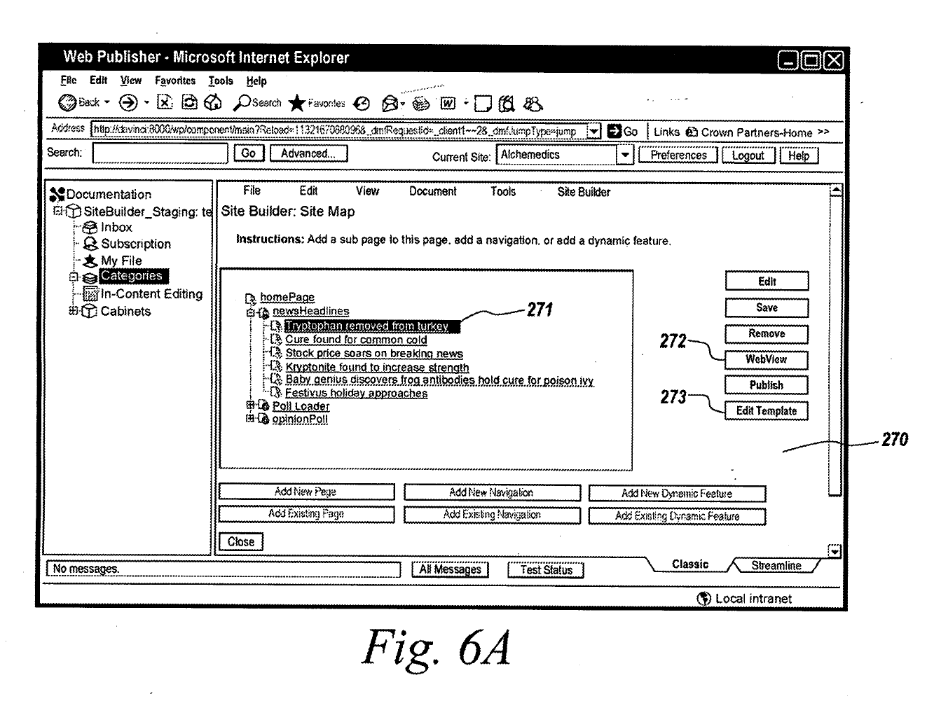

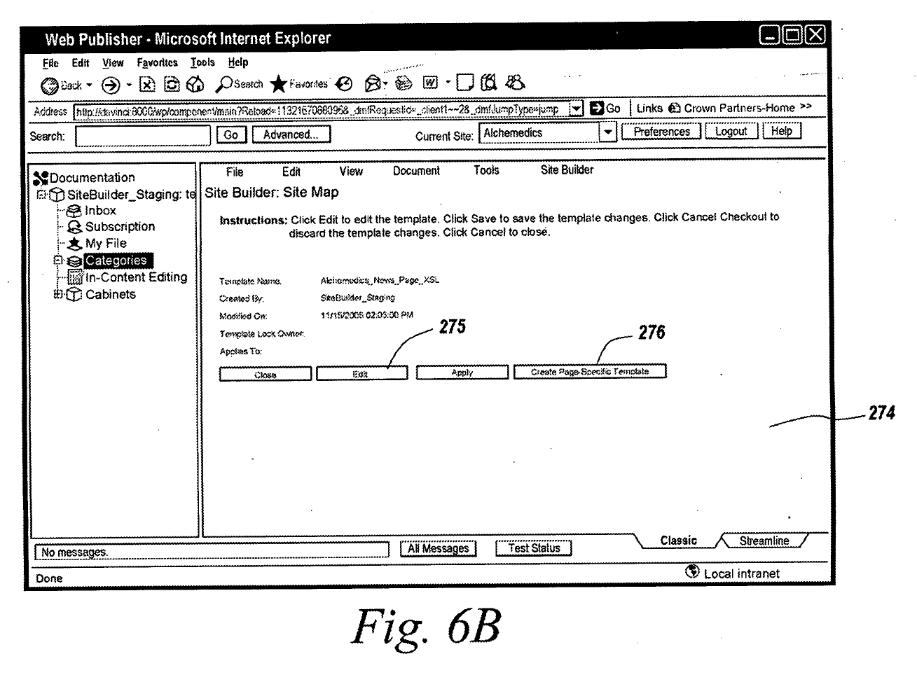

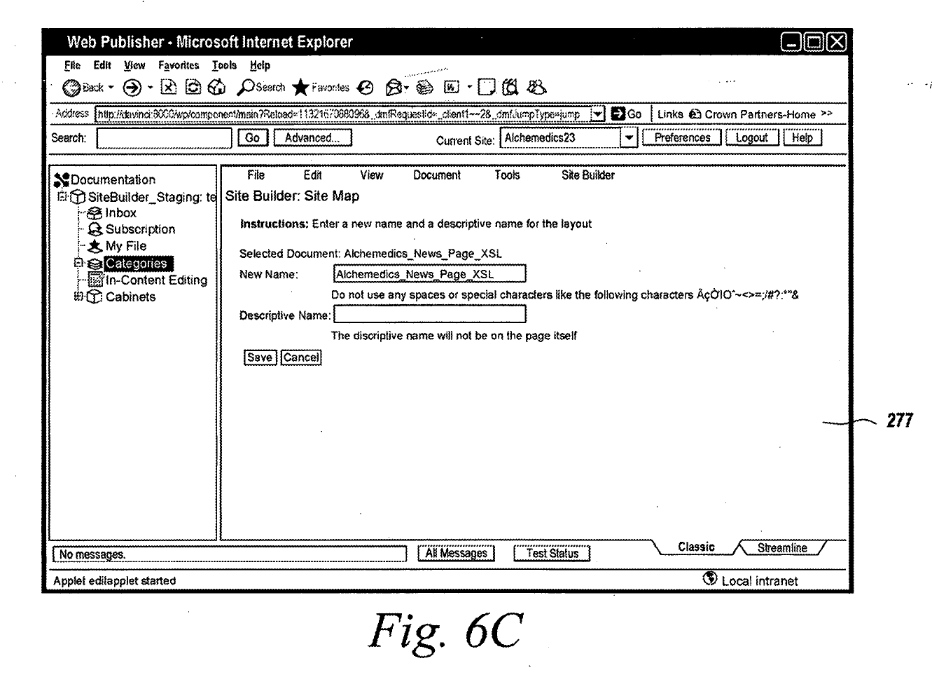

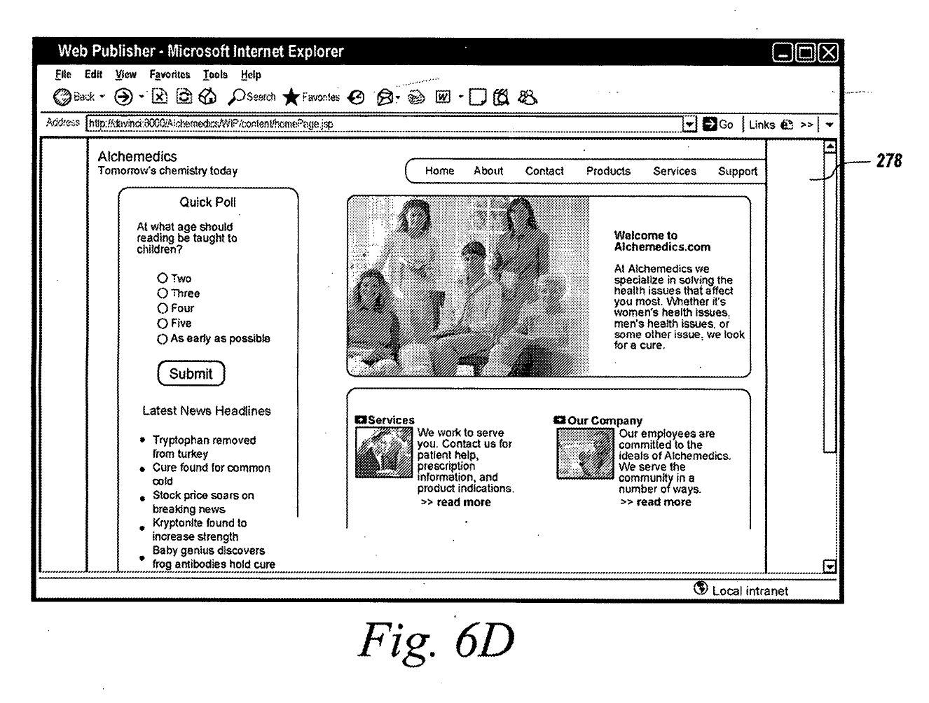

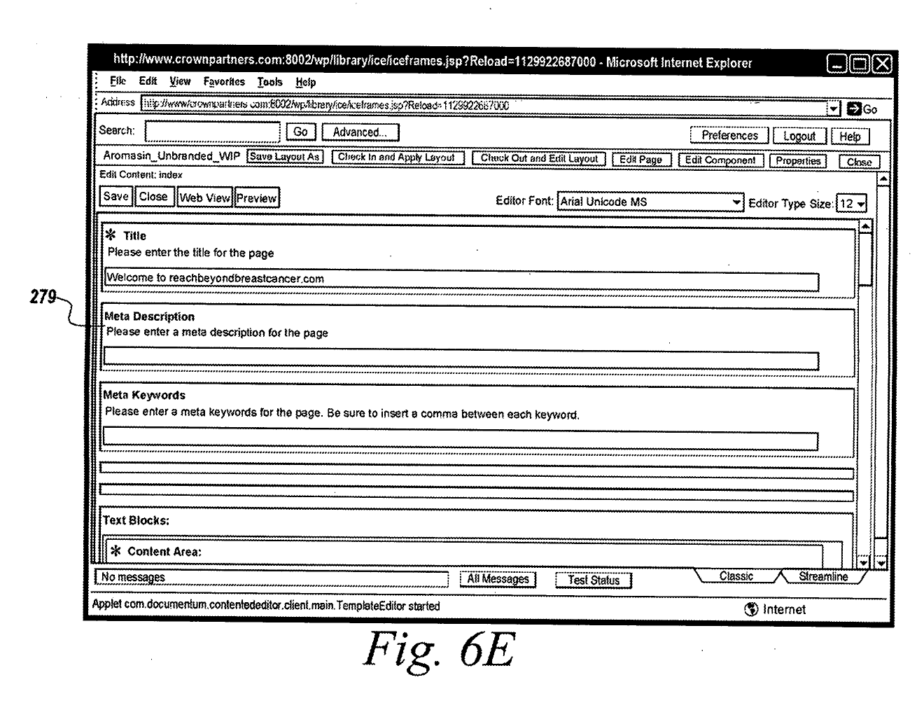

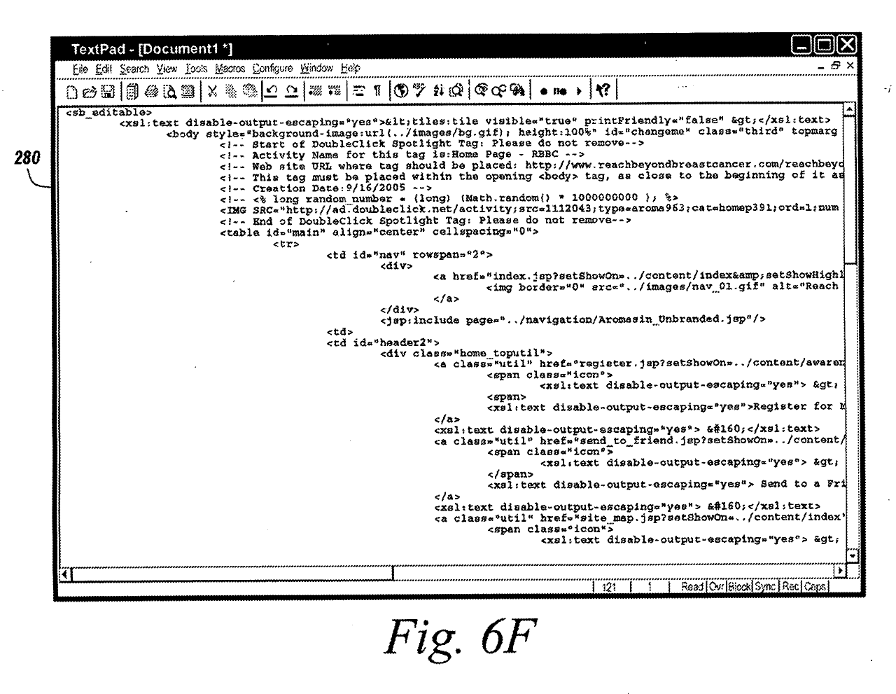

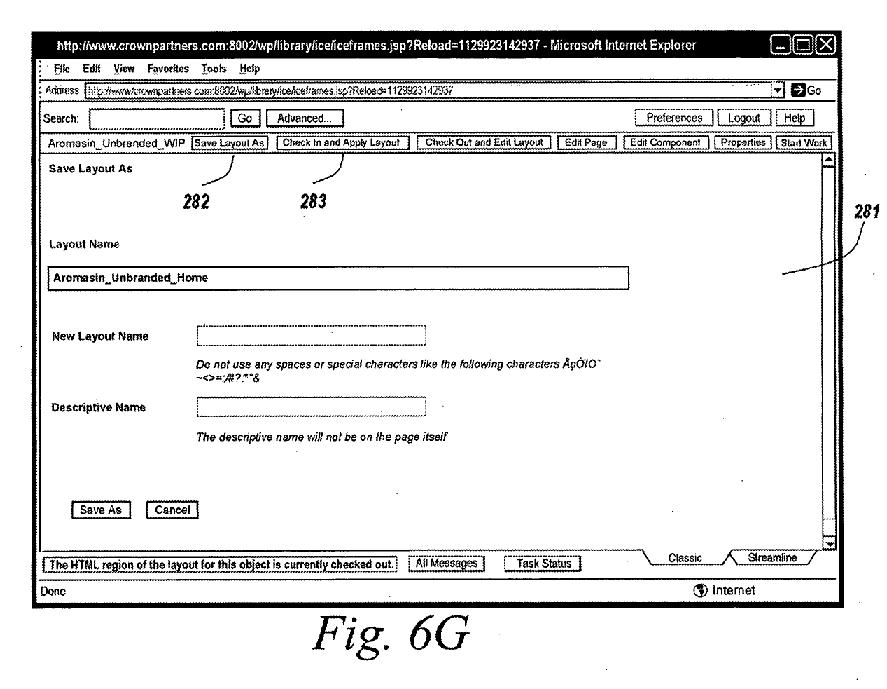

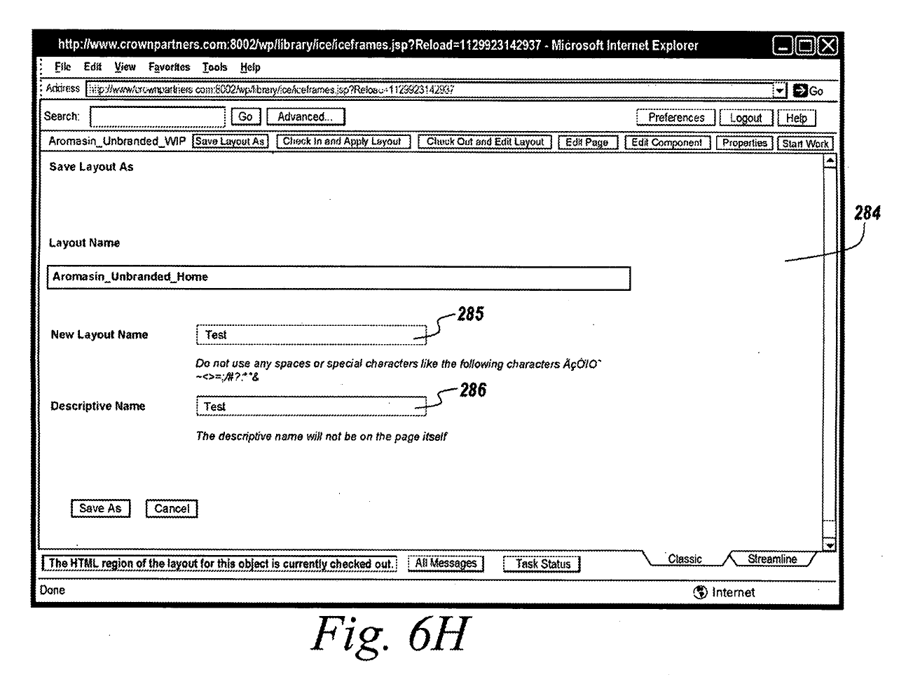

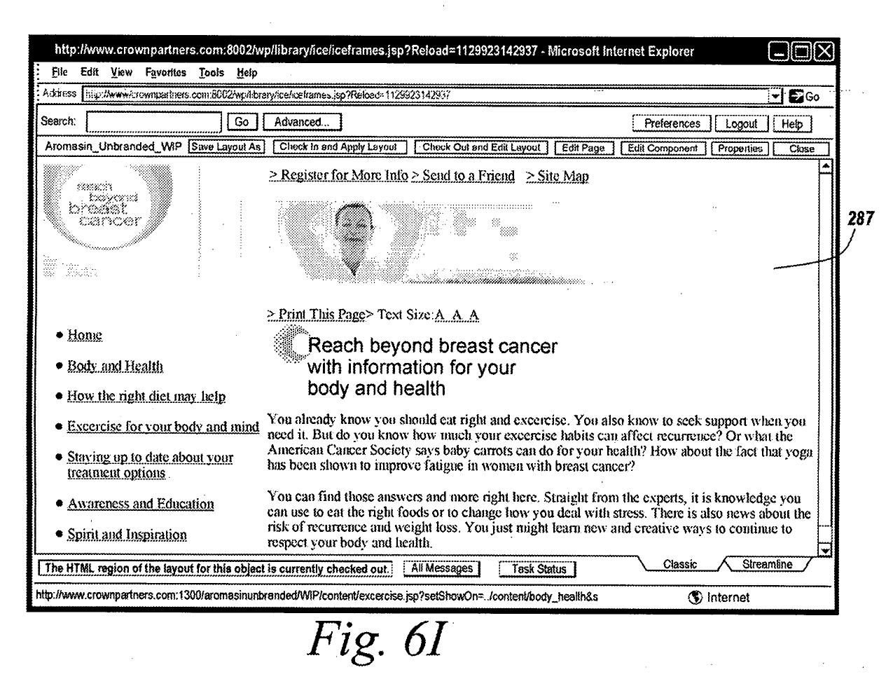

Examples of the user interface that may be used by the web publishing enhancement application 6 to edit templates, layout and code are illustrated in the screenshots of FIG. 6A-6I. FIG. 6A is a screenshot 270 of the site map graphical user interface that allows the user to edit templates. The user may select the web page 271 for which the user wishes to edit the template. The user is also presented with indicators which may allow the user to go to a Webview 272 of the page or edit the template 273. Upon selecting the edit template indicator 273, the screenshot 274 of FIG. 6B is displayed. The user may edit the template embedded HTML code by selecting the edit button 275 or create a new page-specific template 276 by selecting the indicator. In the event the page-specific option 276 is selected, the graphical user interface displayed in the screenshot 277 shown in FIG. 6C allows a user to enter a new template name and descriptive name. FIG. 6D shows a screenshot 278 of a graphical user interface that may be displayed as a result of selecting a webview command from the site map. The user may then select commands in order to use the content editor to make changes as depicted in the screenshot 279 of FIG. 6E and screenshot 280 of FIG. 6F. The user may also be presented with a check-in and apply layout button 282 as shown in the screenshot 281 of FIG. 6G. The selection applies the layout to the current content file. The user may then click an indicator “Save Layout As” 283 which allows users to create a duplicate of the layout and displays the layout in the in-context editor. The user may enter parameters for a new layout name 285 and descriptive name 286 via the graphical user interface depicted in screenshot 284 of FIG. 6H and the new layout may be displayed for the user's review using existing content without applying the layout to the content file as shown in screenshot 287 of FIG. 6I.

Another aspect of the web publishing enhancement application of the present invention is its use of CSS (cascading style sheets). CSS is used by both the authors and readers of web pages to define colors, fonts, layout and other aspects of document presentation. CSS is designed primarily to enable the separation of document structure (written in HTML or a similar markup language) from document presentation (written in CSS). Once the site has been created as outlined above, the page elements that are used to build content must be uploaded. These page elements include images, JavaScript and CSS classes. The process by which the web publishing enhancement application 6 treats the CSS class files differs from conventional mechanisms used in other web publishing applications. Conventional mechanisms for using CSS in web publishing suffer from three major drawbacks. First, in order to prevent concurrent editing and to facilitate versioning, conventional web publishing applications place a lock on CSS files when a user edits the CSS classes within the file. The drawback is a slower site update process due to the serial nature of these updates by multiple users. Secondly, conventional web publishing applications do not allow editing of CSS files to take place concurrently with the editing of web pages. The CSS file must also be separately opened and published manually in addition to the opening and publishing of the web page. Finally, conventional web applications do not allow CSS classes to be applied to content without editing HTML code directly. The web publishing enhancement application 6 of the present invention addresses all three drawbacks. First the CSS class file is parsed into separate objects which can be edited in parallel by multiple users. These classes are merged and published automatically when the changes are committed resulting in both parallel work and shorter cycle time for editing of CSS classes. Secondly, the web publishing enhancement application 6 allows the multiple users to edit CSS classes while they are editing content pages. This reduces the amount of time it takes to create pages because users don't have to navigate back and forth between the CSS file and web page. Finally, the web publishing enhancement application 6 allows CSS classes to be applied to content using a point-and-click method which does not require access to or knowledge of HTML.

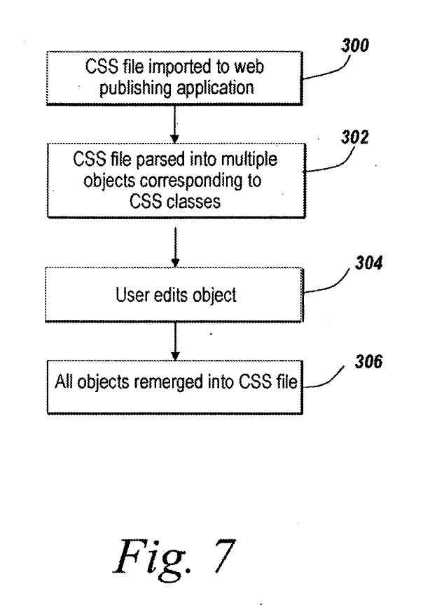

The process by which the CSS tool 10 of the present invention imports CSS files is illustrated in the flowchart of FIG. 7. In one implementation, the CSS files (as well as images and JavaScript can be uploaded to the underlying web publishing application 4 before beginning). The user begins the sequence by importing a CSS file to the web publishing application 4 (step 300). The imported CSS file is parsed into multiple objects with each object corresponding to a separate CSS class (step 302). The user may then edit one of the parsed objects corresponding to the CSS class (step 304). The present invention allows multiple users to edit the parsed objects in parallel and allows the parsed objects to be edited while the user is editing a page to which the CSS classes are being applied. Following the editing, the objects are remerged back into a single CSS file (step 306).

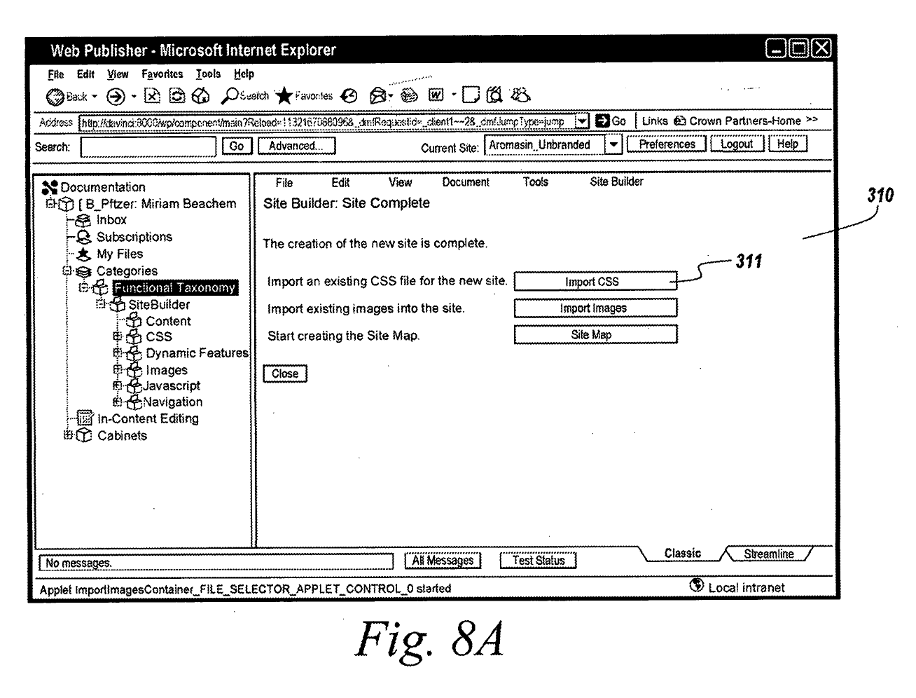

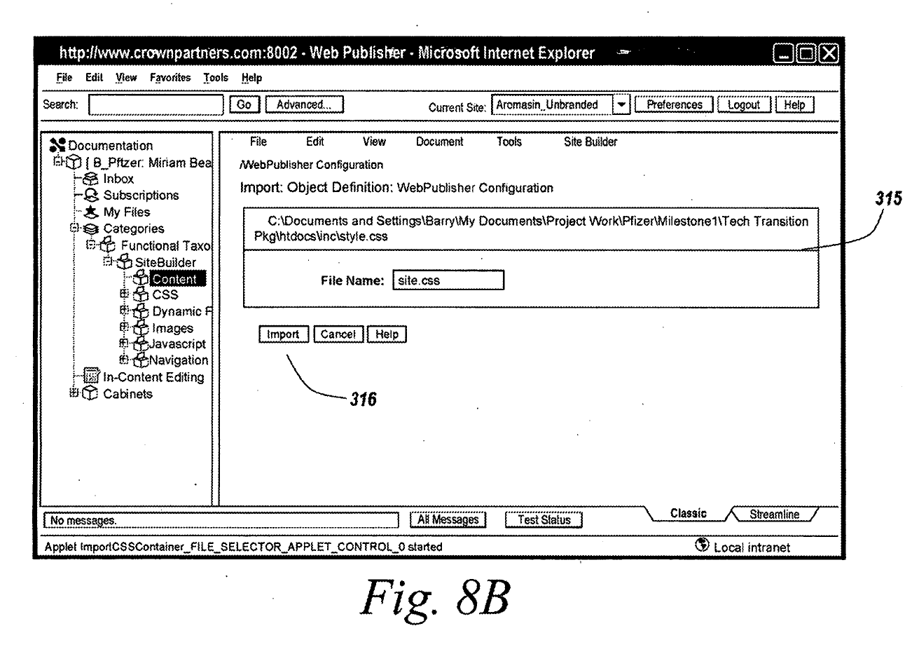

Examples of the user interface that may be used by the web publishing enhancement application 6 to import CSS files are illustrated in the screenshots of FIG. 8A and 8B. As depicted in the screenshot 310 of FIG. 8A, the web publishing enhancement application 6 presents a user with an indicator 311 that allows the user to import a CSS file. The user browses directories and selects a desired CSS file for importation. Once the user has selected the desired file, the user may select an import command 316 as shown in the screenshot 315 in FIG. 8B.

The present invention also generates web pages using XML (a recommended practice in web site development because of the flexibility associated with XML) by providing a page creation tool to create pages for websites using XML schemas, rule sets and XSL to create and edit XML files. The page creation tool also programmatically generates HTML based on the saved XML files. The use of XML templates allows rapid development of web sites compared to conventional reliance upon custom XML structures.

While many web publishing applications use XML templates to generate pages, the web publishing enhancement application 6 uses pre-developed templates based on a universal XML schema. The universal schema defines XML schemas 16 which provide structure for the pieces of the pages being generated including the title, body and descriptions. Rule sets 18 associated with particular XML schemas 16 direct the drawing of dialog boxes through which a user may specify controls to be included on a web page under design. The web publishing enhancement application 6 provides pre-configured rule sets 18 that are compatible with the provided universal XML schema.

XSL style sheets are used by conventional web applications to transform XML content pages into HTML, Java™ Server Pages, Active Server Pages, and other Web publishable formats. Conventionally, due to the custom nature of the XML schemas used within the content, developers must create the XSL stylesheets that are compatible with the XML schemas. In contrast, with the use of a standardized universal XML schema, the present invention can automatically generate a compatible XSL stylesheet. The graphical user interfaces of the web publishing enhancement application 6 exposes the HTML code embedded within the generated XSL stylesheets so that users that are familiar with HTML can edit the stylesheet without knowledge of XSL.

The present invention may be provided as one or more computer-readable programs embodied on or in one or more mediums. The mediums may be a floppy disk, a hard disk, a compact disc, a digital versatile disc, a flash memory card, a PROM, a RAM, a ROM, or a magnetic tape. In general, the computer-readable programs may be implemented in any programming language. Some examples of languages that can be used include FORTRAN, C, C++, C#, or JAVA. The software programs may be stored on or in one or more mediums as object code. The code may run in a virtualized environment such as in a virtual machine. Multiple virtual machines running the code may be resident on a single processor.

Since certain changes may be made without departing from the scope of the present invention, it is intended that all matter contained in the above description or shown in the accompanying drawings be interpreted as illustrative and not in a literal sense. Practitioners of the art will realize that the sequence of steps and architectures depicted in the figures may be altered without departing from the scope of the present invention and that the illustrations contained herein are singular examples of a multitude of possible depictions of the present invention.

We claim:

1. A method for creating an enhanced site map for a web site, the method comprising:
providing a user interface to a web publishing application, the user interface enabling the creation of a site map for a web site with a plurality of pages, the site map providing a view of a web site structure and a location from which to create site content and site navigation; and
creating, with the user interface, the site map.

2. The method of claim 1, further comprising:
adding a home page to the site map; and
associating at least one navigation file to the home page, the navigation file including at least one page.

3. The method of claim 2, further comprising:
adding, via the site map, at least one page to the navigation file.

4. The method of claim 3 wherein the page added to the navigation file is empty of content.

5. The method of claim 3 wherein a collection of content is added to the at least one page added to the navigation file using a template.

6. The method of claim 5, further comprising:
selecting the template from the site map; and
editing the template.

7. The method of claim 6 wherein the editing of the template edits the layout of the template.

8. The method of claim 7, further comprising:
applying the edited layout to a current content file.

9. The method of claim 6 wherein a user edits a collection of embedded HTML in the template.

10. The method of claim 9 wherein the template is an XSL template.

11. The method of claim 2, further comprising:
editing, via the site map, a collection of content in the at least one page included in the navigation file.

12. The method of claim 11 wherein the editing comprises editing the layout of the at least one page.

13. The method of claim 2 wherein the home page that is added to the site map is an existing page.

14. The method of claim 2 wherein the home page that is added to the site map is created from a template.

15. Tire method of claim 1, further comprising:
programmatically generating documentation for the web site based on the site map.

16. The method of claim 1, wherein the site map groups a plurality of pages into a plurality of groups and further comprising:
providing a mechanism in the site map allowing a user to pan from a first group of pages to a second group of pages.

17. The method of claim 1, wherein the site map groups a plurality of pages into a plurality of multi-level groups and further comprising:
providing a mechanism in the site map allowing a user to zoom within a first group of pages from a higher level of grouped pages to a lower level of grouped pages.

18. A method for utilizing CSS (Cascading Style Sheet) style classes with a web publishing application, the method comprising:
importing a CSS file to a web publishing application;
parsing each of a plurality of CSS classes within the CSS file into a plurality of separate objects, each separate object corresponding to a CSS class;
editing one of the plurality of separate objects; and
remerging the plurality of separate objects including the one of the plurality of separate objects that underwent editing into a merged CSS file.

19. The method of claim 18 wherein at least two of the plurality of separate objects are edited in parallel and remerged into a merged CSS file.

20. The method of claim 19 wherein the editing of the at least two separate objects occurs while the user is editing the content of at least one page with the web publishing application.

21. The method of claim 18, further comprising;
providing an interface that enables a user to select at least one of the plurality of separate objects representing CSS classes; and
selecting, through the interface, at least one of the plurality of separate objects representing a CSS class; and
applying programmatically the selected object to a collection of content in a page being edited with the web publishing application.

22. A system for creating pages for web sites, comprising:
a plurality of XML templates;
a universal XML schema defining a plurality of XML schemas included in the XML templates, each of the plurality of XML schemas defining structure for at least a portion of a page being generated using at least one of the plurality of XML templates;
at least one rule set, the at least one rule set associated with at least one of the plurality of XML schemas, the at least one rule set directing the drawing of a dialog box through which a user may specify a control to be included on the page; and
a user interface enabling the selection of at least one of the plurality of XML templates.

23. The system of claim 22, further comprising:
an XSL stylesheet, the XSL stylesheet programmatically generated based on at least one of the plurality of XML schemas.

24. The system of claim 23 wherein the user interface exposes a collection of HTML for editing within the XSL stylesheet.

25. A physical medium for use with a computing device, the physical medium holding computer-executable instructions for creating an enhanced site map for a web site, the instructions comprising:
instructions for providing a user interface to a web publishing application, the user interface enabling the creation of a site map for a web site with a plurality of pages, the site map providing a view of a web site structure and a location from which to create site content and site navigation; and
instructions for creating, with the user interface, the site map.

26. The medium of claim 25, wherein the instructions further comprise:
instructions for adding a home page to the site map; and
instructions for associating at least one navigation file to the home page, the navigation file including at least one page.

27. The medium of claim 26, wherein the instructions further comprise;
instructions for adding, via the site map, at least one page to the navigation file.

28. The medium of claim 27 wherein a collection of content is added to the at least one page added to the navigation file using a template.

29. The medium of claim 28, wherein the instructions further comprise:
instructions for selecting the template from the site map; and
instructions for editing the template.

30. The medium of claim 29 wherein the editing of the template edits the layout of the template.

31. The medium of claim 30 wherein a user edits a collection of embedded HTML in the template.

32. The medium of claim 31 wherein the template is an XSL template.

33. The medium of claim 27, wherein the instructions further comprise;
instructions for editing, via the site map, a collection of content in the at least one page included in the navigation file.

34. The medium of claim 33 wherein the editing comprises editing the layout of the at least one page.

35. The medium of claim 27 wherein the home page that is added to the site map is an existing page.

36. The medium of claim 27 wherein the home page that is added to the site map is created from a template.

37. The medium of claim 26, wherein the instructions further comprise:
instructions for programmatically generating documentation for the web site based on the site map.

38. A physical medium for use with a computing device, the physical medium holding computer-executable instructions for utilizing CSS (Cascading Style Sheet) style classes with a web publishing application, the instructions comprising:
instructions for importing a CSS file to a web publishing application;
instructions for parsing each of a plurality of CSS classes within the CSS file into a plurality of separate objects, each separate object corresponding to a CSS class;
instructions for editing one of the plurality of separate objects; and
instructions for remerging the plurality of separate objects including the one of the plurality of separate objects that underwent editing into a merged CSS file.

39. The medium of claim 38 wherein at least two of the plurality of separate objects are edited in parallel and remerged into a merged CSS file.

40. The medium of claim 39 wherein the editing of the at least two separate objects occurs while the user is editing the content of at least one page with the web publishing application.

41. The medium of claim 38, wherein the instructions further comprise:
instructions for providing an interface that enables a user to select at least one of the plurality of separate objects representing CSS classes; and
instructions for selecting, through the interface, at least one of the plurality of separate objects representing a CSS class; and
instructions for applying programmatically the selected object to a collection of content in a page being edited with the web publishing application.
